(19) United States
(12) Patent Application Publication
(10) Pub. No.: US 2017/0157637 A1
(43) Pub. Date: Jun. 8, 2017

(54) Applicator for Applying a Photocurable Composite Material over a Large Surface of an Object, and Applicator Element for an Applicator

(71) Applicant: KDS Holding GmbH, Wesseling (DE)

(72) Inventor: Dinko Jurcevic, Köln (DE)

(21) Appl. No.: 15/320,323

(22) PCT Filed: Jul. 13, 2015
(86) PCT No.: PCT/DE2015/100300

§ 371 Date: Dec. 20, 2016

(30) Foreign Application Priority Data
Jul. 11, 2014 (DE) 20 2014 103 202.9

(51) Int. Cl. B05C 9/12; B05B 9/08; B05C 17/01; B05D 1/28; B05C 5/02; B05D 3/06; B05D 1/26; B05D 1/02; B05B 7/24; B05C 17/03

(52) U.S. Cl. CPC B05C 9/12; B05B 7/2405; B05B 9/085; B05C 17/01; B05C 17/0341; B05C 5/0254; B05D 3/06; B05D 1/26; B05D 1/02; B05D 1/28

(57) ABSTRACT

The invention relates to an applicator for applying a photocurable composite material over a large surface of a component, having a reservoir for the composite material and at least one lamp for curing the photocurable composite material, and according to the invention—the reservoir comprises at least one discharge region for the photocurable material, through which the photocurable material can be supplied to an applicator elements;—the applicator element is opaque to the light emitted by the lamp;—the photocurable material can be applied to the surface or spread on the surface of the component by contact of the applicator element with the surface. The invention further relates to an applicator element for an applicator, having at least one lamp and designed like a nozzle, the applicator element applying the photocurable material to the surface and/or spreading the photocurable material on the surface of the component by contact with the surface.

### CROSS REFERENCE TO RELATED APPLICATIONS

This application is the U.S. national stage of International Application No. PCT/DE2015/100300, filed on 2015 Jul. 13. The international application claims the priority of DE 202014103202.9 filed on 2014 Jul. 11; all applications are incorporated by reference herein in their entirety.

### BACKGROUND

The present invention relates to an applicator for applying a photocurable composite material over a large surface of an object and an applicator element according to the preamble of the first patent claim and also an applicator element for the applicator.

Materials of different viscosities are metered for various purposes by means of an applicator. The materials can be liquid or viscous. The applicator can be manually operated depending on the application and intended use.

For example, hot glue guns are known for applying conventional adhesives, which can be provided with a light for illuminating the work area, according to 102 17 306 A1. The curing of the dispensed adhesive requires a long time, however. Furthermore, there is a risk of injury due to the high temperature of the hot glue guns.

Handheld devices for dispensing and mixing viscous liquids are also known, which are used in the dental field, for example. Such a solution is described in DE 199 35 292 A1. To illuminate the treatment region, in a gun-like handheld device, an optical fiber is provided for illuminating the treatment region, which is connectable via a coupling to a source. The optical fiber is provided with a rotatable optical unit, which bundles the light onto the treatment region.

A system made of an applicator device for applying liquids over a large surface, in the form of a paint roller or spray gun, from which the liquid is applicable onto a work area, is described in DE 10 2007 060 247 A1. The surface 20 is illuminated in a targeted manner by means of an illumination unit, which causes a contrast between coated and uncoated surfaces. A decisive disadvantage in this case is that it often takes multiple hours until the applied material has dried. In particular if the surface is to be walked on, driven on, or used in another manner, this is a decisive disadvantage.

Furthermore, the above-mentioned solutions are not provided for applying photocurable material and the illumination means are accordingly not provided for this purpose and are also not capable of curing the dispensed material.

Coating a plate-shaped workpiece is known from document DE 102004043725 A1. A corona discharge is performed on the surface of the workpiece before the coating of the plate-shaped workpiece. Powdered lacquer is applied to the surface of the workpiece thus prepared with the aid of a coating unit. In a subsequent curing unit, firstly the applied powdered lacquer is melted by means of infrared radiation, so that a very glossy, closed lacquer coating results, which is subsequently cured by ultraviolet light (light in the nonvisible spectrum).

An impregnating resin formulation, containing component A, consisting of an unsaturated polyester resin, component B, consisting of an unsaturated ester resin, containing polyether structures, component C, consisting of a further polymer, which is different from (A) and (B), or of an epoxy/curing agent system, possibly curing agent, accelerator, stabilizers, additives, and rheology additives, and also optionally fillers, wherein component (A) is different from component (B), and the production thereof and the use thereof for impregnating windings, for producing base materials of surface insulation materials and for coating planar assemblies, is known from DE 102008037468 A1.

The formulation is to be made UV-photocurable by way of the use of photoinitiators, for example, phosphine oxides and ketalene. However, such UV illuminants are not harmless to health.

A flash device for curing photocurable materials, a method, and a set are described in document DE 10 2010 060 422 A1. A flash is generated thereby, wherein an optical fiber which is flexible in regions can be used for this purpose. The flash device is designed, for example, like a ballpoint pen, which can be turned on and off by a button press. The flash device can have a reservoir to accommodate photocurable material, which is arranged in a housing. The device can be designed, for example, in the form of a pen having a reservoir for the photocurable material. An LED lamp is provided at the end of the housing opposite to the outlet opening. After dispensing the photocurable material, the housing has to be rotated transversely in relation to its longitudinal axis. The dispensed material is then cured by turning on the LED lamp.

A set is known from document DE 20 2011 109 785 U1, which has at least one metering device having photocurable material, which is detachably accommodated in a housing. Furthermore, a light-emitting unit for curing the photocurable material in the form of an LED lamp is arranged on the housing. A metering unit for dispensing the photocurable material is detachably connected to the metering device, wherein the metering unit and/or a metering channel of the metering unit for dispensing the photocurable material has a removable closure. The metering channel and the light-emitting unit are embodied or provided at two opposing end regions of the set, wherein the housing has at least one opening for the manually controlled metering of the photocurable material and a device for the detachable accommodation of the light-emitting unit.

It is disadvantageous in this case that the reservoir in the form of the metering device is additionally jacketed by a housing. It also has an unfavorable effect on the processing process that the LED is arranged at the end of the housing opposite to the metering channel, because it is thus necessary to invert the set after the dispensing of the photocurable material and only then to start the curing process by actuating the LED.

An applicator for manually-controlled application of a photocurable composite material is also known from document WO 2014/008894 A2, which has a very small-dimensioned outlet opening for the photocurable composite material, however, whereby it is also not possible to provide large surface regions of objects rapidly and easily with the photocurable material.

The three above-mentioned solutions therefore have the decisive disadvantage that they can only dispense and cure the photocurable material in the form of lines or dots, and the photocurable material can run in an undesired manner before it is cured.

### SUMMARY

The invention relates to an applicator for applying a photocurable composite material over a large surface of an object. The applicator has a reservoir for the composite material and at least one illuminant for curing the photocurable composite material. The reservoir has at least one outlet region for the photocurable material, via which the photocurable material can be supplied to an applicator element. The applicator element is light-opaque for the light emitted by the illuminant, and the photocurable material can be applied to the surface and/or can be distributed on the surface by contact of the applicator element with the surface of the component.

### DETAILED DESCRIPTION

The object of the present invention is to propose an applicator for applying a photocurable composite material over a large surface and an applicator element for the applicator, which has a simple structural design and enables the photocurable material to be dispensed onto larger surface regions and to be cured after the dispensing.

The object according to the invention is achieved by the features of patent claims 1 and 14.

Advantageous embodiments arise from the dependant claims.

According to the invention, the applicator for applying a photocurable composite material over a large surface has a reservoir, in which the photocurable composite material is located (for example, in liquid, partially liquid, gel type, or viscous form or in a paste state), furthermore the applicator has at least one illuminant for curing the photocurable composite material, wherein according to the invention the reservoir has at least one outlet region for the photocurable material, via which the photocurable material can be supplied to an applicator element, the applicator element is light-opaque for the light emitted by the illuminant, and the applicator element applies the photocurable material to the surface and/or distributes it on the surface by contact with the surface of the component.

The applicator element can thus have, in the direction toward the component, a relatively large contact surface for applying the photocurable material to the surface of the component, so that large surface regions of a component can also be coated rapidly and easily with the photocurable material and the photocurable material is cured by the light of the illuminant after the application.

The applicator element has a larger surface (contact surface) in relation to the component in comparison to the outlet region of the reservoir in this case.

At least one outlet region for the photocurable material, via which the photocurable material can be supplied to an applicator element, adjoins the reservoir.

The illuminant(s) is/are preferably arranged behind the applicator element in a movement direction of the applicator.

The applicator element preferably has a large application width and one or more illuminants are arranged on the applicator along the application width (b).

Alternatively, one or more illuminants can be arranged on the applicator at least in regions along a circumference of an application surface of the applicator element. Light can be emitted onto the photocurable material, which is applied to the surface using the applicator element, by the illuminant(s).

The applicator element can have at least one through-flow opening, wherein photocurable material dispensed from the outlet region of the reservoir can be supplied to a first end of the through-flow opening and the photocurable material can be dispensed through a second end of the through-flow opening. The through-flow opening preferably widens like a nozzle in the direction toward the second end, so that a larger/broader dispensing region is provided for the photocurable material, which is substantially broader than the outlet region of the reservoir.

The outlet region of the reservoir for the photocurable material can also either be embodied, in the direction toward the applicator element, in the form of a slot or can have a plurality of outlet openings arranged adjacent to one another and/or one behind another and can be adapted to the width of the applicator element.

An applicator element, which applies the photocurable material which exits from the outlet region to the surface to be coated, then adjoins the outlet region of the reservoir. This can be, for example, a rubber lip, a silicone lip, or a metal lip, or also a roller, an applicator roller, a foam-like or sponge-like body, or the like. The roller or applicator roller can consist, depending on the surface which is to be coated, of plastic, textile material, bristles, foam, rubber, metallic material, or a combination of the above-mentioned materials. For example, the material of the applicator roller/roller which is suitable for the surface to be coated can be determined in a simple manner by several previous experiments.

The applicator element can also have a structure which is transferable to the photocurable material applied to a surface, so that after the curing of the photocurable material, a structured surface is formed thereby.

One or more illuminants, which emit light in the visible wavelength range (preferably in the blue longwave range) and radiate it on to the material applied to the surface and cure it immediately, are arranged laterally adjacent the applicator element (behind the applicator unit in the movement direction of the applicator) or distributed around the circumference of the applicator element. An LED tape or an LED strip is preferably used for this purpose.

To prevent the curing of the material in/on the applicator element, a shield is provided between the LEDs and the applicator element or between the contact region of the applicator element with the surface of the component and the illuminant, wherein the shield is light-opaque for the light emitted by the illuminant.

The shield can be arranged on the applicator element or the applicator element itself can also form the shield.

The illuminant(s) is/are preferably arranged on the applicator element and/or the shield and/or on an enclosure of the applicator element and/or on a housing of the applicator itself.

It is possible that the illuminant can be turned on upon pressing the applicator element onto the surface to be coated and can be turned off upon lifting the applicator unit off of the surface to be coated.

The illuminant(s) preferably emit or emits light in the visible wavelength range in particular (preferably in the blue longwave range) and radiate or radiates onto the photocurable material applied to the surface.

The illuminant(s) is/are preferably designed in the form of multiple LEDs, an LED light strip, or an LED tape, is/are supplied with power via at least one battery or at least one rechargeable battery, and can be turned on and off by means of a switch.

It is also possible to form the applicator element like a nozzle having a broad outlet opening and to arrange the illuminants/LEDs on the dispensing element. It is possible that the applicator has at least one illuminant, which can be turned on and off, which is designed as a cartridge gun, a spray gun, or a spray nozzle, etc. This applicator has at least one shield, at the outlet region/dispensing region of the photocurable material, between the contact region, in which the photocurable material is applied to the surface by the applicator element, and the illuminant. The shield can be arranged on the applicator element or can be formed by the applicator element itself.

The shield is preferably arranged at least on one side on the dispensing region of the cartridge gun, spray gun, or spray nozzle, and the at least one illuminant is arranged on the side of the shield facing away from the dispensing region.

Using the invention, surfaces/surface regions which are subjected to particular stresses can be coated. It is particularly advantageous in this case that the dispensed composite material immediately cures completely upon irradiation by the LEDs, so that the surfaces and objects coated thereby are rapidly usable again.

A further advantage is that the cured material is removable again if needed.

Furthermore, it is possible to wet different surfaces of objects, which adjoin one another, lie one on top of another, or overlap one another, with the photocurable material and thus to connect the objects to one another (after the curing of the material).

The invention furthermore relates to an applicator element for an applicator, which has at least one illuminant and is formed like a nozzle, wherein the applicator element applies the photocurable material to the surface by contact with the surface of the component and/or distributes it on the surface. The applicator element is preferably removably fastenable.

It is thus possible to attach the applicator element to a conventional cartridge gun, spray gun, or spray nozzle, which has photocurable material in its reservoir, and to coat surfaces using such an applicator.

### BRIEF DESCRIPTION OF THE DRAWINGS

The invention will be explained in greater detail hereafter on the basis of exemplary embodiments.

In the figures:

FIG. 1 shows an applicator for applying over a large surface area in a front view,

FIG. 2 shows a side view with a longitudinal section through the reservoir, during the application of the material onto a surface,

FIG. 3 shows a variant of the fastening of a first object on a second object,

FIGS. 4 and 5 show an applicator having an applicator element in the form of an applicator roller, in which the photocurable material is supplied to the applicator roller from the inside,

FIGS. 6 and 7 show an applicator having an applicator element in the form of an applicator roller, to which the photocurable material is supplied from the outside by spraying,

FIG. 8 shows an applicator element in the form of an applicator pad for applying over a large surface area, in a housing part having circumferential LEDs,

FIG. 9 shows an applicator in the form of a cartridge gun,

FIG. 10 shows an applicator in the form of a spray gun.

### DETAILED DESCRIPTION OF THE PREFERRED EMBODIMENTS

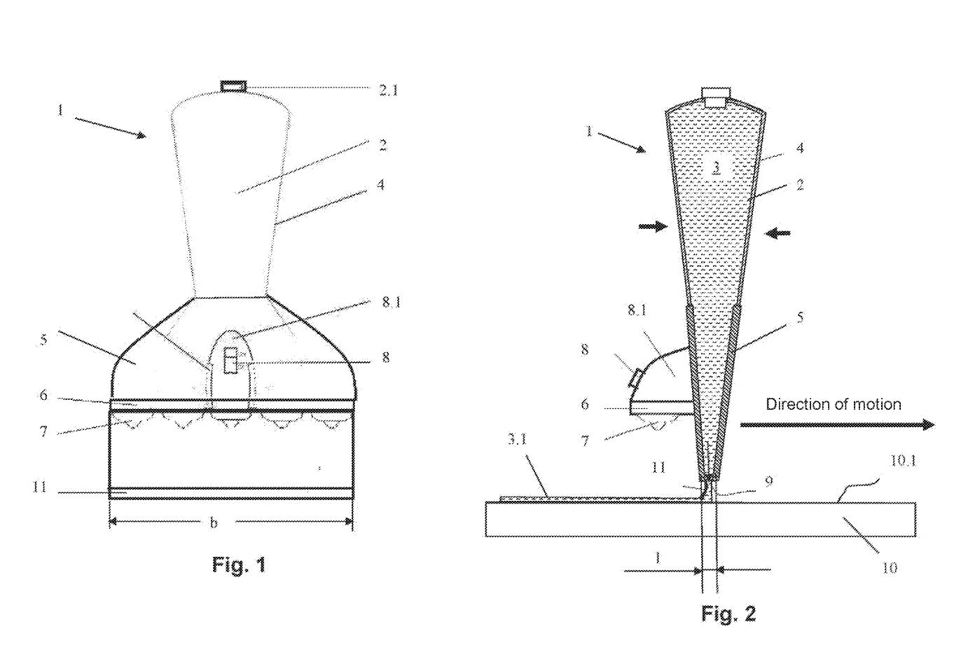

FIGS. 1 and 2 show the schematic illustration of an applicator 1 according to the invention, which has a reservoir 2, in which, according to FIG. 2, photocurable material 3 is provided, for example, in liquid form or paste form. The applicator has a handle 4 and an applicator element 5, which are connected to one another around the circumference and are formed hollow overall and are used as the reservoir 2. The handle 4 consists of an elastically compressible material and applicator element 5 consists of a material which is solid in comparison thereto. An LED strip 6 having multiple LEDs 7 is fastened to the applicator element 5, which can be turned on and off via a switch 8.1, which is arranged in a housing 8.

The handle 2 is simultaneously used as a reservoir 4 for the photocurable material, and has a closable filling opening 2.1 at its upper end, through which photocurable material is refillable. Alternatively, a replaceable cartridge used as a handle 2 can also be provided, in which the photocurable material is provided.

The applicator element 5 has, on its side facing downward over the entire width b, a slotted outlet opening 9 having a length l (see FIG. 2), through which the photocurable material 3 exits. A downward facing rubber lip 11 is provided in the region of the outlet opening 9, which also acts as an applicator element and using which the material dispensed onto the surface 10.2 of an object 10 is distributed.

It is possible to coat large surface areas rapidly and efficiently with the photocurable material by way of the application width b, which is multiple times greater than the slot length l. The photocurable material is cured immediately after it is applied by the LEDs, which are also provided over the application width b.

According to FIG. 2, the photocurable material is applied using the tool/applicator to a surface 10.1 of an object 10 in that the tool is drawn in the indicated movement direction over the surface. A rubber lip 11 is used for better distribution on the surface. The material is immediately cured by the turned-on LEDs 7 when the light emitted by the LEDs 7 is incident thereon, so that an extremely solid seal 3.1 forms on the surface, which can be pulled off again if needed.

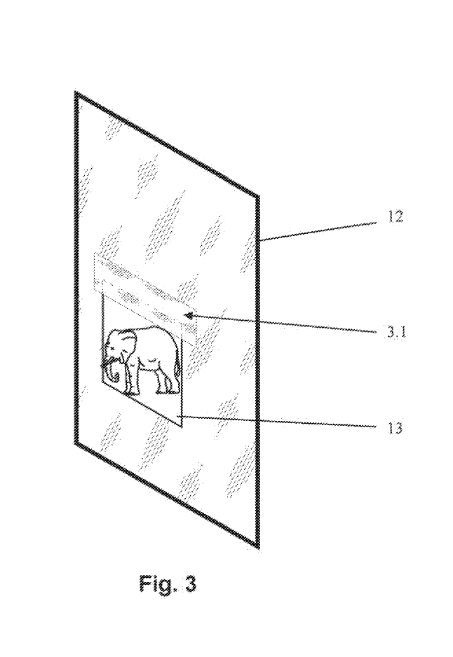

According to FIG. 3, in this manner an image 13 is fastened on a window pane 12 using the photocurable seal 3.1.

Of course, a variety of other possible applications are provided, with which surfaces can be protected easily and effectively and decorative elements are fastenable on the surfaces using the applicator if needed.

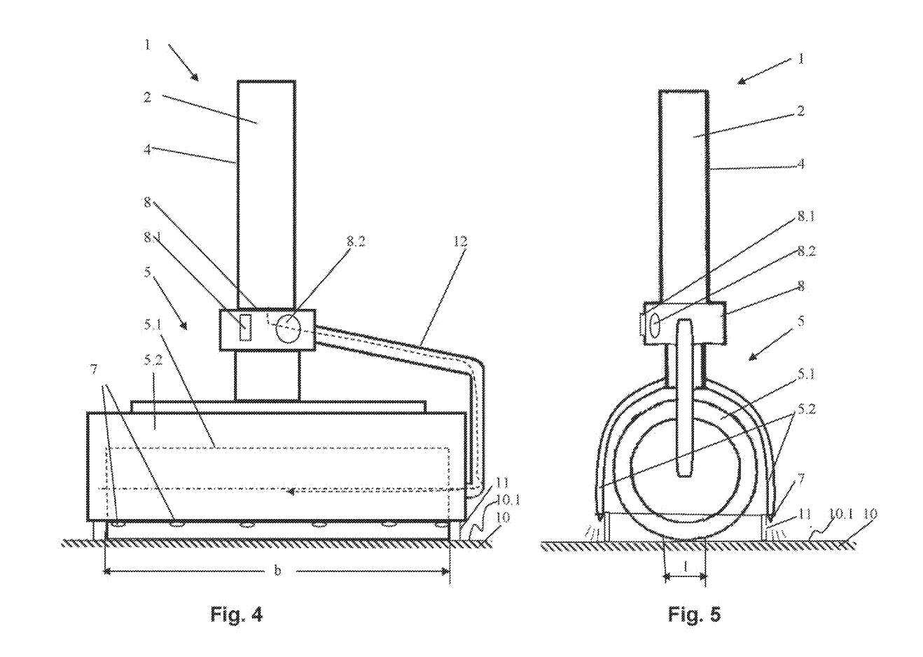

Alternatively, it is also possible, according to FIGS. 4 and 5, to apply the photocurable material using an applicator, in which the applicator element is designed in the form of an applicator roller 5.1.

FIGS. 4 and 5 show the schematic illustration of such an applicator 1 according to the invention, which also has a reservoir 2, in which material 3 is provided in liquid form or paste form. The applicator 1 has a handle 4 and an applicator element in the form of an applicator roller 5.1, which is mounted so it is rotatable similarly to a painting roller. The handle 4 is used as the reservoir 2.

A shield 5.2 is provided, which encloses the applicator roller 5.1 as much as possible, so that the photocurable material accommodated by the applicator roller 5.1 does not cure on the applicator roller 5.1. The shield 5.2 preferably extends on both sides of the applicator roller 5.1, as is visible in FIG. 5 (or also only on one side).

On the end of the shield which faces downward here, multiple LEDs 7 are provided, preferably over the entire application width b of the applicator roller 5.1. The LEDs can be turned on and off via a switch 8, which is arranged in a housing 8.1.

Furthermore, a pump (not shown and identified) is arranged in the housing 8.1.

Furthermore, a mount 12 leads from the housing 8.1 to the applicator roller 5.1, on which the applicator roller 5.1 is accommodated so it is rotatable. Through the mount 12, which is embodied as a tube, still liquid photocurable material is conveyed by the pump from the reservoir 2 into the applicator roller 5.1 and dispensed on the outer circumference of the applicator roller 5.1. For this purpose, a further switch 8.2 is provided on the housing 8.1 for actuating the pump. Furthermore, the power supply for the LEDs and the pump are arranged in the housing. The handle 4, which is embodied as a cartridge having the reservoir 2, is fastened on the housing 8 by means of a quick-release connection, whereby the connection of the reservoir 2 to the pump is established.

It is also possible to provide a rubber lip 11 around the shield, which is arranged between the applicator roller 5.1 and the LEDs and extends up to the surface 10.1 of an object 10 to be coated and is used, on the one hand, in addition for distributing the photocurable material dispensed using the applicator roller 5.1 onto the surface 10.1, and also for shielding the light emitted by the LEDs 7. The material dispensed using the applicator roller 5.1 is first cured when the LEDs 7 are incident thereon during an advancing movement of the applicator 1. Material which is located on or at the applicator roller 5.1 and on the surface inside the shield 5.2 remains in the liquid or partially liquid state, in which application is possible, due to the shield 5.2.

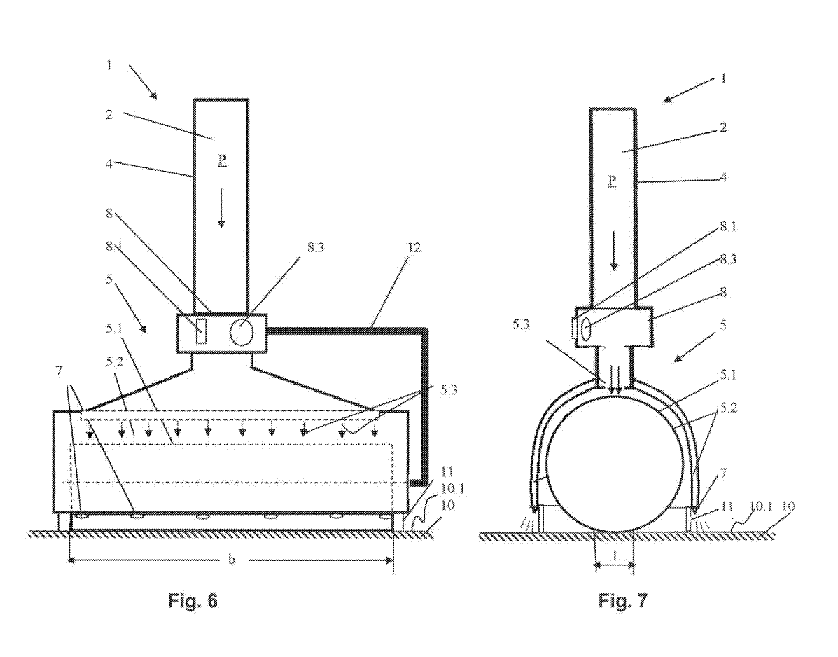

The applicator is also designed in the form of an applicator roller 5.1 having LEDs 7 in FIGS. 6 and 7. However, the photocurable material is supplied to the applicator roller 5.1 from the outside by spraying here. The reservoir has multiple outlet openings 5.3 on its lower side, through which the photocurable material is dispensed onto the applicator roller 5.1.

The applicator also has a handle 4 here, which is used as the reservoir 2.

A shield 5.2 is also provided, which encloses the applicator roller 5.1 as much as possible, so that the photocurable material accommodated by the applicator roller 5.1 does not cure on the applicator roller 5.1. The shield 5.2 extends on both sides of the applicator roller 5.1, as in FIGS. 4 and 5.

Multiple LEDs 7 are also provided on the shield, preferably over the entire application width b of the applicator roller 5.1. The LEDs can be turned on and off via a switch 8, which is arranged in a housing 8.1.

A pump (not shown and identified) can be arranged in the housing 8.1, via which the photocurable material is conveyed to the outlet opening. It is also possible to design the reservoir as a pressurized container, so that the photocurable material is output upon actuation (similarly as with a spray nozzle). For example, a switch 8.3 on the housing 8.1 can also be used to open the spray nozzle. In the variant according to FIGS. 6 and 7, a mount 12 also leads from the housing 8.1 to the applicator roller 5.1, on which the applicator roller 5.1 is accommodated so it is rotatable. Furthermore, the power supply for the LEDs and the pump is arranged in the housing. The handle 4, which is embodied as a cartridge with the reservoir 2, is preferably fastened on the housing 8 by means of a quick-release connection.

A rubber lip 11 was also arranged here around the shield, which is located between the applicator roller 5.1 and the LEDs and extends up to the surface 10.1 of an object 10 to be coated.

It is also possible according to one exemplary embodiment (not shown), to conduct the photocurable material to the applicator roller via a separate line and to dispense the photocurable material not via a pump or a pressurized container, for example, but rather manually onto the applicator roller.

Applying material, which is used for sealing the surfaces, onto surfaces by means of an applicator sponge is known.

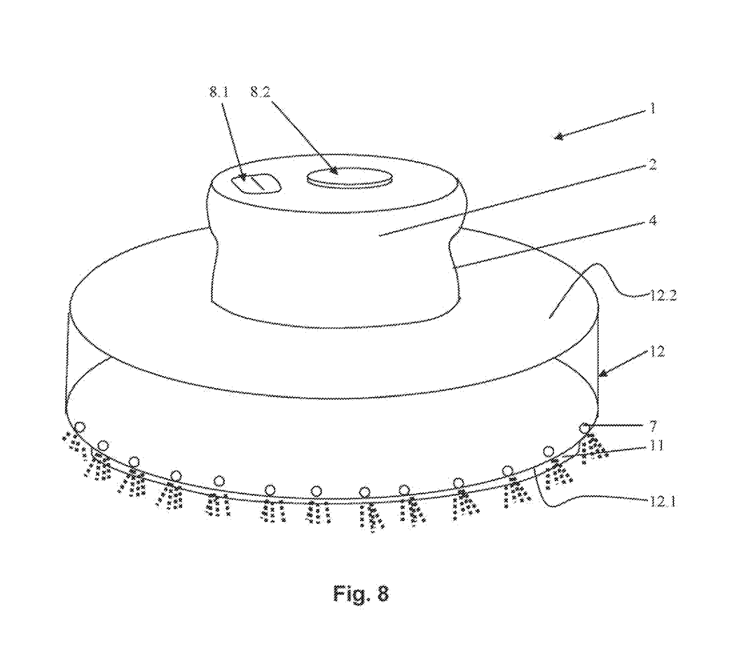

To also enable application of photocurable materials over large surfaces using such applicator sponges, it is proposed according to FIG. 8 that an applicator 1 be designed so that a conventional applicator sponge 11 can be accommodated thereby, which is used as an applicator element for the photocurable material.

For this purpose, the applicator 1 has a housing part 12, which is open downward and into which the applicator sponge 11 is insertable, so that the applicator sponge 11 protrudes somewhat beyond the lower edge 12.1, so that the sealed surface (not shown) is not damaged by the lower edge 12.1 of the housing part 12. The housing part has multiple LEDs around the circumference in the direction toward its lower edge 12.1, which emit light so that it is not incident on the region of the applicator sponge 11 which protrudes out of the housing part 12, so as not to prematurely cure the photocurable material located on the applicator sponge 11 in an undesired manner.

A reservoir 2 is provided for the photocurable material, which adjoins the upper side 12.2 of the housing part 12 and is simultaneously used as the handle 4. A connection, via which the material located in the reservoir can be dispensed onto the applicator sponge 11, leads from the reservoir 2 to the housing part 12. This is performed, for example, via a pump (not shown), which is arranged either in the housing part 12 or in the handle 4. A switch 8.1 for turning the LEDs 7 on and off and a switch 8.2 for actuating the pump are provided on the handle 4.

The switch 8.1 for the LEDs and the switch 8.2 for the pump are designed differently, so as not to confuse them and to make operation easier. By actuating the pump, the photocurable material is dispensed onto the application sponge and applied via it onto a surface to be sealed using the photocurable material. Simultaneously or subsequently, the LEDs are turned on and the applied material is thus cured. Using the applicator according to the invention, it is possible to seal surfaces rapidly and conveniently using a photocurable material.

Thus, for example, by using an applicator according to the invention, vehicle body parts on vehicles can be rapidly and easily provided with such a coating, which is multiple times harder than known lacquer seals and ensures substantially better protection of the vehicle body parts against environmental influences, rock impacts, scratches, etc.

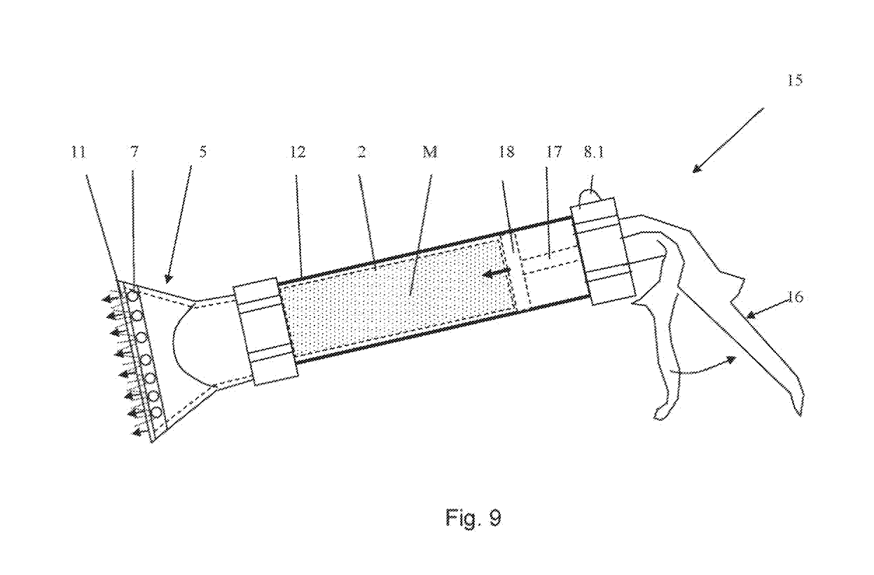

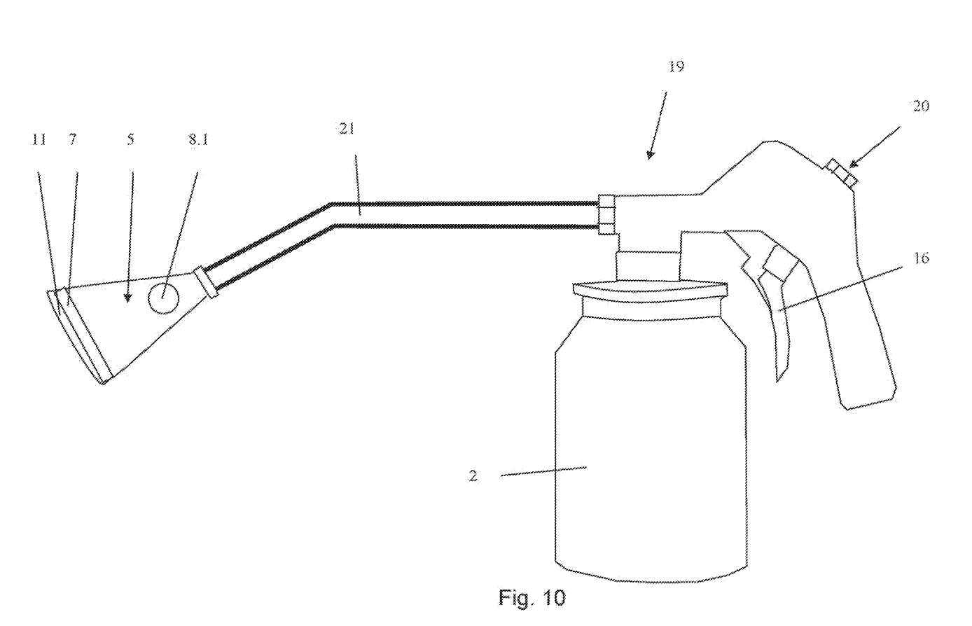

A further variant of the design of the applicator in the form of a cartridge gun 15 is shown in FIG. 9.

A reservoir 2 in the form of a cartridge, in which the photocurable material M is located, is insertable into a tubular housing part 12. By actuating the hand lever 16, a rod 17 is pressed against the bottom 18 of the cartridge from the rear. The bottom 18 thus moves into the interior of the cartridge and at the same time presses the material M located in the cartridge out of the nozzle at the front—which is the applicator element 5 here. The applicator element 5 (preferably made of plastic), which is designed as a nozzle having a wide slotted outlet opening, also has a rubber lip 11 on its end, which is used for distributing the photocurable material dispensed onto a surface of the component and simultaneously forms a shield for the LEDs. Furthermore, multiple LEDs 7, adapted to the width of the outlet opening, are provided on the applicator element, which LEDs radiate on to the photocurable material, which is dispensed through the outlet opening and distributed using the rubber lip 11, and cure this material. The photocurable material can be applied onto a broad surface region by the nozzle (applicator element 5), which widens toward the outlet opening. The applicator has a switch 8.1 for turning the LEDs 7 on and off.

The switch 8.1 can alternatively also be provided on the nozzle, so that the nozzle (the applicator element 5) having LEDs and the switch provided for it (and optionally a rubber lip or a lip made of another material) can be provided as an auxiliary part for an otherwise conventional cartridge gun—of course in conjunction with the photocurable material available in the reservoir.

FIG. 10 shows an applicator in the form of a spray gun 19. The reservoir 2 in which the photocurable material is located is connected to the spray gun 19 and a compressed air feed 20 is attached thereto. By actuating the hand lever 16, the photocurable material is conveyed here via a tube 21 to the applicator element 5, which is designed as a nozzle. LEDs 7 (only indicated here) and also a rubber lip 11, which can also be omitted, however, are located on the applicator element 5. It is important that the LEDs do not shine directly on the outlet opening (not shown here) of the nozzle (of the applicator element 5), but rather only on the coated surface (not shown here).

The switch 8.1 for turning the LEDs on and off is located on the nozzle (the applicator element 5).

The applicator element 5 has a through-flow opening here, wherein the photocurable material dispensed from the outlet region of the reservoir can be supplied to a first end of the through-flow opening and the photocurable material is dispensed through a second end of the through-flow opening. The through-flow opening preferably widens in the direction toward the second end.

The nozzle/the applicator element 5 having the LEDs 7 and the switch 8.1 and optionally having a rubber lip can also be provided here as an auxiliary part to a conventional spray gun, so that the application of the photocurable material is possible using a conventional spray gun.

It is apparent that a corresponding power supply in the form of a battery or a rechargeable battery is associated with the illuminant/the LEDs, which can also be integrated into the applicator element 5 (the nozzle) or into the applicator in another way.

1. An applicator for applying a photocurable composite material over a large surface of an object, having a reservoir for the composite material, and having at least one illuminant for curing the photocurable composite material, characterized in that
the reservoir has at least one outlet region for the photocurable material, via which the photocurable material can be supplied to an applicator element,
the applicator element is light-opaque for the light emitted by the illuminant,
the photocurable material can be applied to the surface and/or can be distributed on the surface by contact of the applicator element with the surface of the component.

2. The applicator according to claim 1, characterized in that at least one outlet region for the photocurable material adjoins the reservoir, via which the photocurable material can be supplied to the applicator element.

3. The applicator according to claim 1, characterized in that the illuminant(s) is/are arranged behind the applicator element in a movement direction of the applicator.

4. The applicator according to any one of claims 1 to 3, characterized in that the applicator element has at least one through-flow opening, and the photocurable material dispensed from the outlet region of the reservoir can be supplied to a first end of the through-flow opening and the photocurable material can be dispensed through a second end of the through-flow opening.

5. The applicator according to any one of claims 1 to 3, characterized in that the reservoir has an outlet region, the width of which essentially corresponds to the application width of the applicator element, and the outlet region is either designed as slotted or has a plurality of outlet openings arranged adjacent to one another and/or one behind another.

6. The applicator according to claim 5, characterized in that the applicator element is designed in the form of a roller, an applicator roller, a body made of foam or a foam-like body, or a rubber or silicone lip or metal lip.

7. The applicator according to any one of claims 1 to 6, characterized in that the applicator element consists of plastic, textile material, bristles, foam, rubber, silicone, metallic material, or a combination of the above-mentioned materials.

8. The applicator according to any one of claims 1 to 7, characterized in that the applicator element, in the direction toward a contact region with the surface of the component, has a structure which is transferable to the photocurable material applied to the surface and is curable using the illuminant.

9. The applicator according to any one of claims 1 to 8, characterized in that a shield is provided between the contact region of the applicator element with the surface of the component and the illuminant, wherein the shield is light-opaque to the light emitted by the illuminant.

10. The applicator according to claim 9, characterized in that the shield is arranged on the applicator element, or the applicator element forms the shield, and the illuminant(s) is/are arranged on the applicator element and/or the shield and/or on an enclosure of the applicator element and/or on a housing of the applicator.

11. The applicator according to any one of claims 1 to 10, characterized in that the illuminant(s) emits or emit light in the visible wavelength range (preferably in the blue wavelength range) and radiate or radiates onto the photocurable material applied to the surface.

12. The applicator according to any one of claims 1 to 11, characterized in that the illuminant(s) is/are designed in the form of multiple LEDs, an LED light strip, or an LED tape, is/are supplied with power via at least one battery or at least one rechargeable battery, and can be turned on and off by means of a switch.

13. The applicator according to any one of claims 1 to 12, characterized in that it is designed like a cartridge gun, a spray gun, or a spray nozzle and is combined with the applicator element and at least one illuminant, which can be turned on and off.

14. An applicator element for the applicator according to claim 1, characterized in that the applicator element has at least one illuminant and is designed like a nozzle, and the applicator element applies the photocurable material onto the surface and/or distributes it on the surface by contact with the surface of the component.

15. The applicator element according to claim 14, characterized in that the applicator element is removably fastenable.
